(19) United States
(12) Patent Application Publication
(10) Pub. No.: US 2003/0197683 A1
(43) Pub. Date: Oct. 23, 2003

(54) Device and method for power saving of wireless mouse

(75) Inventors: Chiung-Chih Huang, Taipei (TW); Chih-Jen Kuo, Taipei (TW)

Correspondence Address: NIXON PEABODY, LLP, 8180 GREENSBORO DRIVE, SUITE 800, MCLEAN, VA, 22102, US

(73) Assignee: LITE-ON TECHNOLOGY CORPORATION

(21) Appl. No.: 10/309,077

(22) Filed: Mar. 10, 2003

(30) Foreign Application Priority Data
Apr. 17, 2002 (TW) 91107833

(51) Int. Cl. G09G 5/08

(52) U.S. Cl. 345/163

(57) ABSTRACT

The present invention discloses a power saving device of a wireless mouse. The power saving device includes a switch and a key. When the wireless mouse is not in use for a period of time, the wireless mouse actuates an interrupt and enters into the sleep mode. If a user wants to use the mouse and touch the key, the key is depressed and the switch is actuated disabling the interrupt. Thus, the wireless mouse is in the operation mode again.

### CROSS REFERENCE TO RELATED APPLICATIONS

This application claims priority of Taiwan Patent Application Serial No. 91107833 entitled “Device and Method for Power Saving of Wireless Mouse”, filed on Apr. 17, 2002.

### FIELD OF THE INVENTION

The present invention relates to an improved power saving method of a wireless mouse, and more particularly, to a power saving method of a wireless mouse in the sleeping mode.

### BACKGROUND OF THE INVENTION

Distinctive connection methods, such as wire or wireless connections, can be used to connect a personal computer and the peripherals. The wire connections between the personal computer and the peripherals may limit the relative disposition locations of the peripherals to the personal computer. Some peripherals, e.g. wireless mice, are coupled to a personal computer with wireless connections to provide convenience. A wireless mouse needs batteries to provide power, and battery's life cycle is limited. Accordingly, the user needs to concern about the power consumption of the wireless mouse.

Since a user does not operate the wireless mouse all the times, one conventional way to save battery power is to force the wireless mouse entering the sleeping mode while not operating. A conventional wireless mouse usually implements the operation mode, idle mode, and sleeping mode. The operation mode has largest power consumption while the sleeping mode has lowest power consumption. Power consumption of the idle mode is between those of the operation mode and the sleeping mode.

In the operation mode, a controller in a wireless mouse has to detect actions of mouse and buttons over the mouse in additional to control over the wireless communication module. In general, the power consumption of the operation mode is 14 mA. The controller turns off the wireless communication module in the idle mode, but still detects actions of mouse and buttons to return to the operation mode. In general, the power consumption of the idle mode is 5-7 mA. In the sleeping mode, the power consumption is 60-120 μA. In the deep sleeping mode, the controller not only turns off the wireless communication module but also does not detect actions of mouse and buttons. In general, the power consumption of the idle mode is 60-110 μA.

Referring to FIG. 1A and FIG. 1B, a conventional power saving method is illustrated. When the wireless mouse is in the idle and sleeping modes, the controller detects actions of buttons. If buttons are activated, the wireless mouse returns to the operation mode from either idle or sleeping modes. The simple holding of the mouse does not render the wireless mouse entering into the operation mode.

Referring to FIG. 1A, a conventional wireless mouse is in the operation mode in step 104. In step 106, the controller in the wireless mouse detects if it is not operated for 1 second. If it is “NO” in step 106, the wireless mouse enters into the idle mode in step 108. The controller checks, in step 110, if the activation of the wireless mouse is made within 5 seconds while in the idle mode. When it is not operated in step 110, the wireless mouse enters into the sleeping mode in step 112. Afterwards, in step 114, the controller checks user actions of the wireless mouse for 600 seconds. The conventional method proceeds to FIG. 1B when the wireless mouse is not operated in step 114.

Referring to FIG. 1B, the wireless mouse enters into the deep sleeping mode in step 118 when it is “NO” in step 114. At this stage, the wireless mouse has not been not used for 10 minutes, e.g. in midnight or weekend when the wireless mouse has not been used for a long period of time. In the deep sleeping mode, the wireless mouse does not respond to the user operations. However, in step 120, the controller counts 680 ms, and then the wireless mouse enters into the idle mode in step 122. Afterwards, in step 124, the wireless mouse checks users operations for 320 ms. The wireless mouse returns to the operation mode in step 104 if it is “YES” in step 124, or returns to the deep sleeping mode in step 118 if it is “NO” in step 124.

The conventional power saving method, as shown in FIG. 1B, performs a loop consuming 1 second while the wireless mouse has not been used for a long period of time. The wireless mouse is in the deep sleeping mode for 680 ms to reduce power consumption and in the idle mode for 320 ms to detect mouse operations. The drawback for the conventional approach is that, when the wireless mouse is in the deep sleeping mode, the controller does not detect mouse operations until it enters into the idle mode. Furthermore, entering into the idle mode regularly consumes more power than the deep sleeping mode.

As discussed above, the conventional power saving method cannot lower power consumption efficiently and cannot also respond to mouse operations immediately while in the deep sleeping mode. A demand for an improved power saving method with these features therefore exists.

### SUMMARY OF THE INVENTION

An aspect of the present invention is to provide a power saving method for a wireless mouse and a mouse with a power saving device.

The present invention discloses a power saving device of a wireless mouse. The wireless mouse has a switch. When the wireless mouse is not in used for a period of time, an interrupt is actuated enabling the wireless mouse to enter into the sleep mode. When a user touches the mouse and actuates the switch, the interrupt is disabled and the wireless mouse returns to the operation mode. There are two methods to actuate the switch. One method is that a key extends out of the housing via an opening, and the switch is actuated when the key is depressed. The other is a cover disposed on the housing, and the switch is actuated when the cover is depressed

### BRIEF DESCRIPTION OF THE DRAWINGS

FIG. 1A and FIG. 1B are flow diagrams showing a conventional power saving method of a wireless mouse.

FIG. 2A and FIG. 2B are flow diagrams showing a power saving method of a wireless mouse in accordance an exemplary embodiment of the present invention.

FIG. 3A is a wireless mouse in accordance with an exemplary embodiment of the present invention.

FIG. 3B is a cross-sectional diagram of a wireless mouse in FIG. 3A.

FIG. 3C is an explosive view of a wireless mouse in FIG. 3A.

FIG. 4A is a wireless mouse in accordance with another exemplary embodiment of the present invention.

FIG. 4B is a cross-sectional diagram of a wireless mouse in FIG. 4A.

FIG. 4C is an explosive view of a wireless mouse in FIG. 4A.

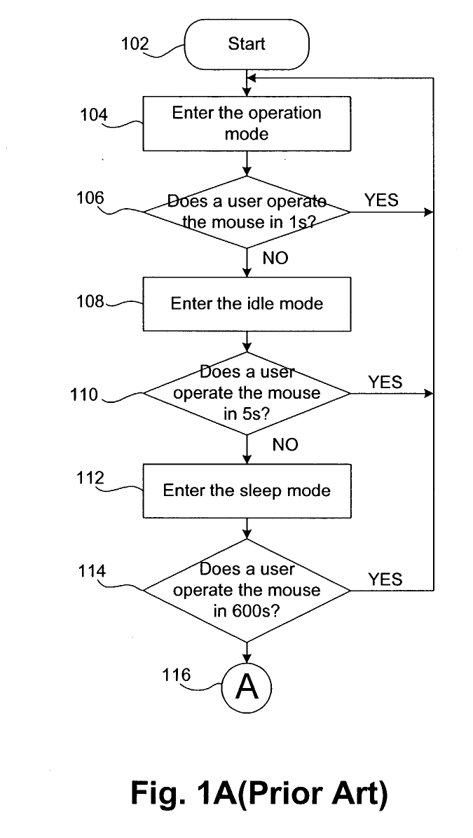

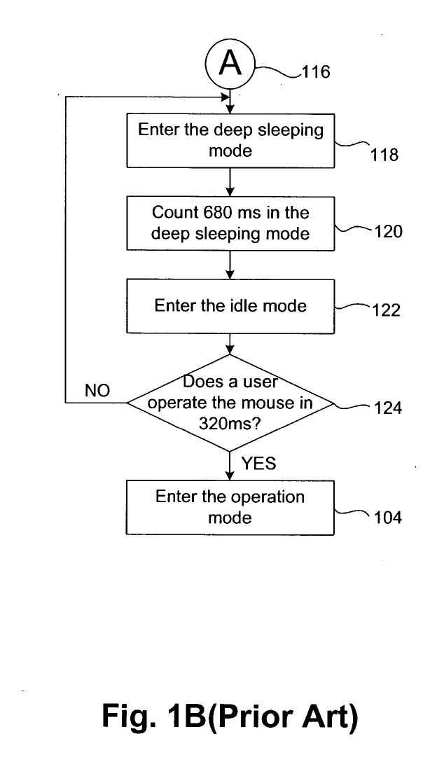

### DETAILED DESCRIPTION OF THE INVENTION

The present invention provides a power saving device for a wireless mouse. Such a wireless mouse consumes less power and, at the same time, is still sensitive to user operations while the wireless mouse is in the sleeping mode.

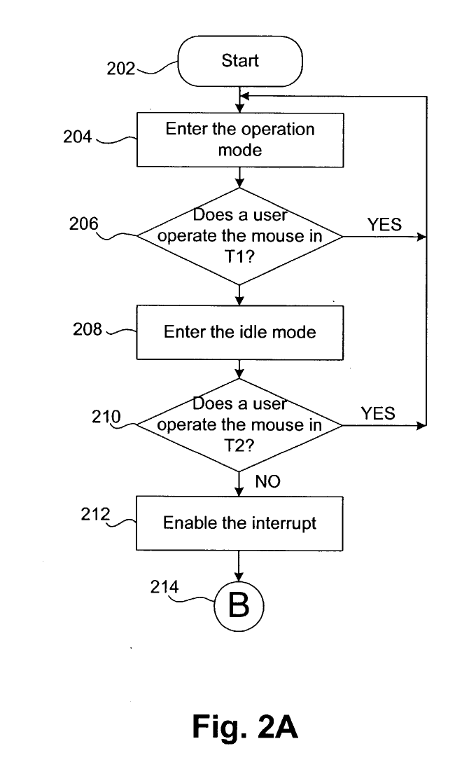

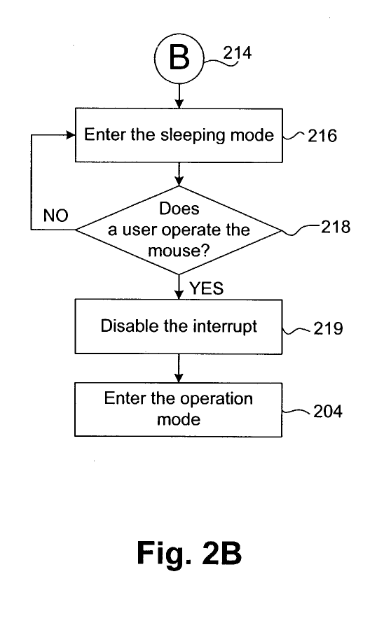

Referring to FIG. 2A and FIG. 2B, an exemplary power saving method is shown in flow diagrams. The wireless mouse is in the operation mode of step 204. When the wireless mouse is not activated for a period of time T1 in step 206, the mouse enters into idle mode in step 208. If the activation interval does not exceed T1, the wireless mouse stays in the operation mode in step 204. When the wireless mouse is in idle mode, a controller checks the wireless mouse in step 210. The wireless mouse returns to an operation mode in step 204 when it is operated in step 210. If it is “NO” in step 210, then step 212 is proceeded and an interrupt is enabled. After the interrupt is enabled, the wireless mouse enters into the sleeping mode in step 216. When a user utilizes the wireless mouse in step 218 and the interrupt is disabled in step 219, the wireless mouse returns to the operation mode in step 204. If the user does not utilize the wireless mouse in step 218, it stays in the sleeping mode in step 216. The length of T1 and T2 may be configured by the power saving method. For example, T1 may be 1 second and T2 may be 5 seconds. T1 maybe 2 seconds and T2 may be 10 seconds.

In the present invention, the wireless mouse enters into the sleeping mode entirely and consumes lowest power. The wireless mouse does not return to the operation mode until the interrupt is disabled. Therefore, the power saving method of the present invention can save more power than that in prior art.

The present invention provides two exemplary embodiments of power saving device for achieving objects of the invention. The power saving device includes a switch coupling to the controller on a print circuit board in the wireless mouse. The switch may be an electronic switch or a leaf spring. When the wireless mouse is not in use for a period of time, it enters into the sleeping mode. When the user utilizes the wireless mouse, the switch is actuated to disable the interrupt, and the wireless mouse returns to the operation mode.

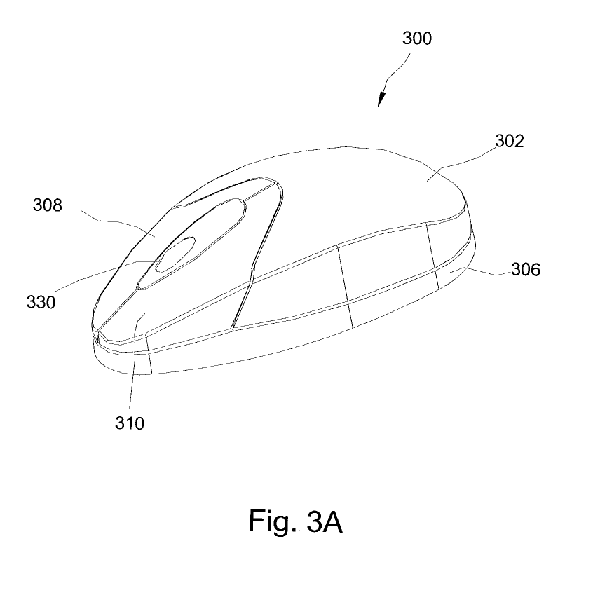

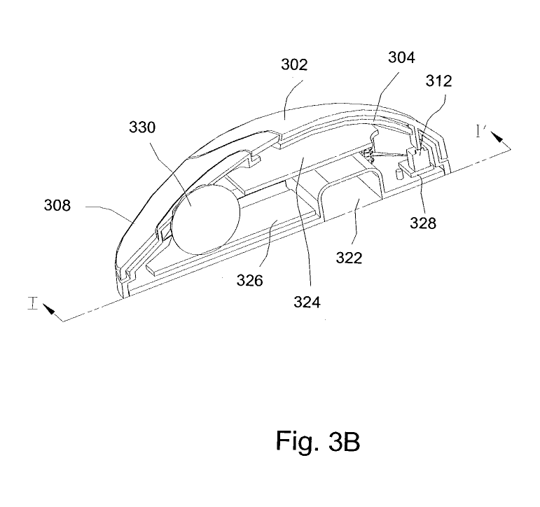

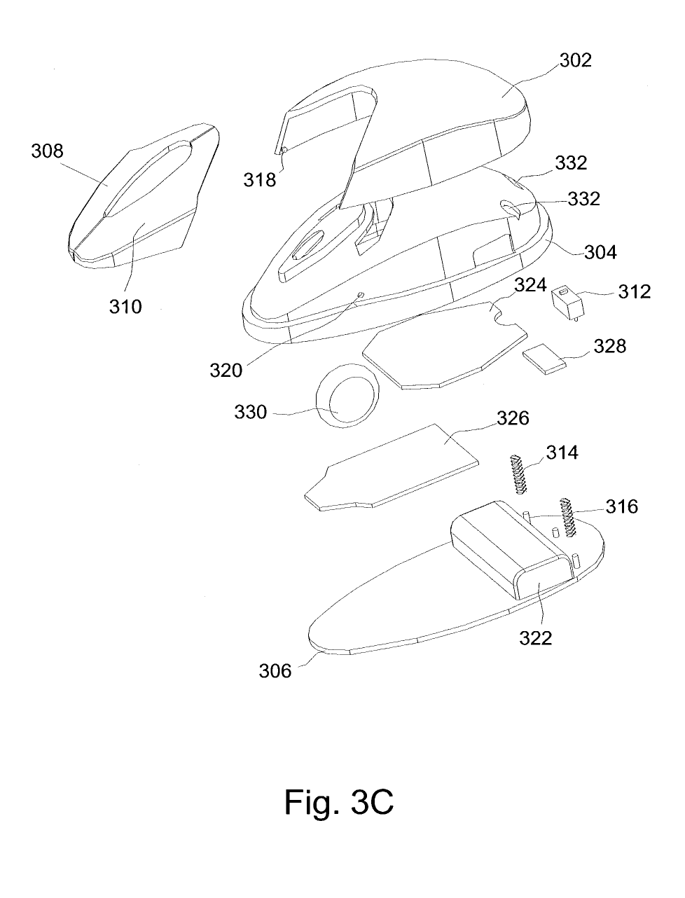

Referring to FIG. 3A and FIG. 3B, wireless mouse 300 is an exemplary embodiment of the present invention. Wireless mouse 300 includes housing 304, wheel 330, and buttons 308, 310. The number of buttons 308, 310 and wheel 330 depends on the wireless mouse design and is not restricted by the appearance in FIG. 3A. Cover 302 is disposed on housing 304. FIG. 3B is a cross-sectional diagram of wireless mouse 300. Cover 302 is coupled to switch 312, and print circuit board 328 is disposed under switch 312. When a user touches cover 302, cover 302 is depressed to actuate switch 312. Consequently, the interrupt is disabled and wireless mouse 300 returns to the operation mode.

FIG. 3C is an explosive view of wireless mouse 300. Housing 304 includes a plurality of holes 332. Cover 302 is coupled to switch 312 by passing through hole 332. Cover 302 returns to an undepressed position by resilience of switch 312 or by resilient units, such as springs 314, 316. Springs 314 and 316 contact to cover 302 via holes 332. Cover 302 has positioning shafts 318, which corresponds to positioning holes 320 located on housing 304. When cover 302 and housing 304 are assembled together, the positioning shafts 318 are inserted into corresponding positioning holes 320, such that cover 302 moves between depressed and undepressed positions. Cover 302 is undepressed while the wireless mouse is not in use and in the sleeping mode. While cover 302 is depressed, wireless mouse disables the interrupt and returns to the operation mode. The operation mode is not disturbed by the interrupt. The interrupt is actuated only if wireless mouse 300 is not operated by a user for a period of time and enters into the sleeping mode.

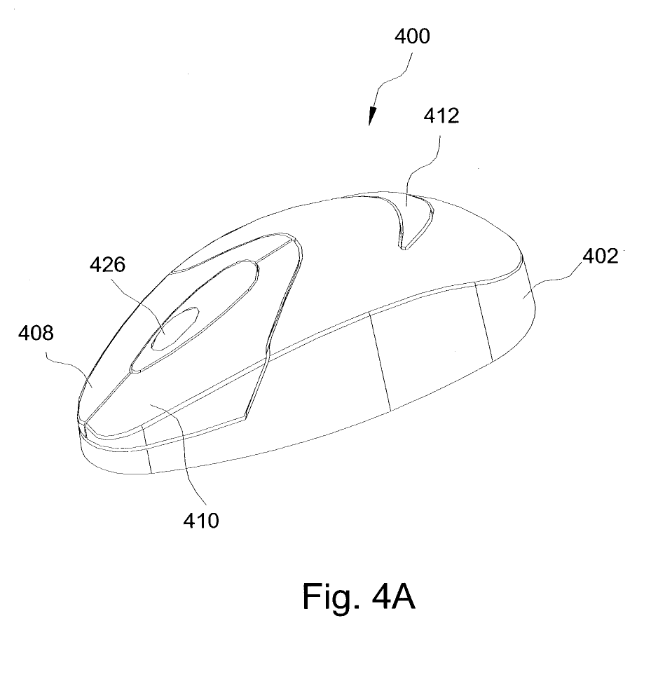

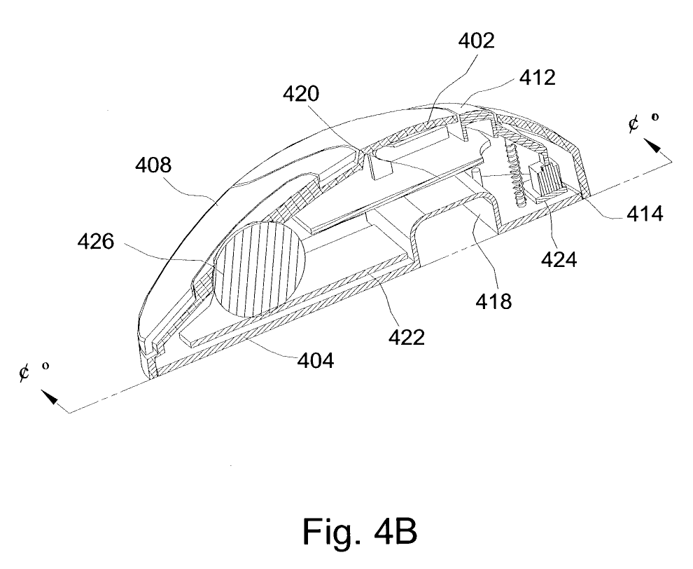

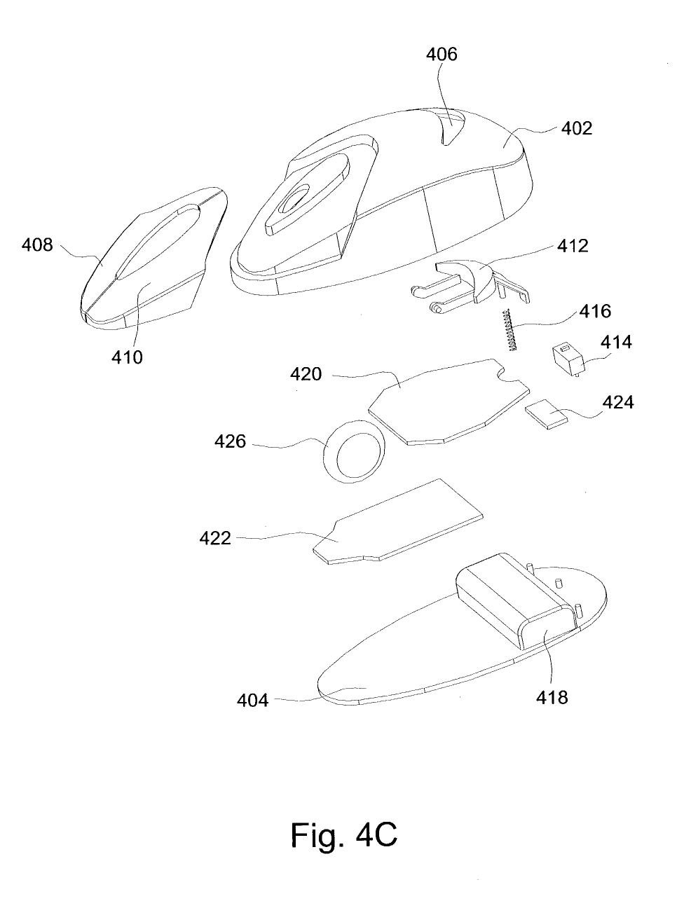

FIG. 4A is another exemplary embodiment of the present invention. Components in wireless mouse 400 are similar to those in wireless mouse 300. The major difference is key 412 replacing cover 302. The shape and position of key 412 varies according to the mouse design. Key 412 may be disposed on an upper side of housing 402 for operation convenience. FIG. 4B is a cross-sectional diagram of wireless mouse 400. Key 412 is coupled to switch 414, and print circuit board 424 is disposed under switch 414. When a user touches key 412, key 412 is depressed to actuated switch 414. Consequently, the interrupt is disabled and wireless mouse 400 returns to the operation mode.

FIG. 4C is an explosive view of wireless mouse 400. Key 412 returns to an undepressed position by resilience of switch 414 or by a resilient unit, such as spring 416. Key 412 is undepressed while the wireless mouse is not in use and in the sleeping mode. While key 412 is depressed, wireless mouse 400 disables the interrupt and returns to the operation mode. The operation mode is not disturbed by the interrupt. The interrupt is actuated only if wireless mouse 400 is not operated by a user for a period of time and enters into the sleeping mode.

While this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as falling within the true scope of the invention.

1. A mouse with a power saving device, the mouse having a housing and a controller, the mouse comprising:
a cover disposed above the housing;
a switch disposed in the housing and connecting to the controller;
when a user does not utilize the mouse for a period of time, the controller actuates an interrupt enabling the mouse to enter into a sleep mode, and when the user touches the cover, the cover actuates the switch to disable the interrupt, such that the mouse returns to an operation mode.

2. The mouse according to claim 1, the housing further comprising a first hole, wherein the switch is connected to the cover via the first hole.

3. The mouse according to claim 1, the mouse further comprising a resilient unit therein, and the housing further comprising a second hole thereon, wherein the resilient unit passes through the second hole and selectively drives the cover to an undepressed position.

4. The mouse according to claim 3, wherein the resilient unit is a spring.

5. The mouse according to claim 1, wherein the switch is an electronic switch.

6. The mouse according to claim 1, wherein the switch is a leaf spring.

7. The mouse according to claim 1, the mouse further comprising a printed circuit board for coupling the controller to the switch.

8. A mouse with a power saving device, the mouse having a housing and a controller, the mouse comprising:
an opening located on the housing;
a key disposed in the housing and extending out of the housing through the opening; and
a switch disposed under the key and coupling to the controller;
when a user does not utilize the mouse for a period of time, the controller actuates an interrupt enabling the mouse to enter into a sleep mode, and when the user touches the key, the key actuates the switch to disable the interrupt, such that the mouse returns to an operation mode.

9. The mouse according to claim 8, the mouse further comprising a resilient unit, wherein the resilient unit selectively drives the key to an undepressed position.

10. The mouse according to claim 9, wherein the resilient unit is a spring.

11. The mouse according to claim 8, wherein the switch is an electronic switch.

12. The mouse according to claim 8, wherein the switch is a leaf spring.

13. The mouse according to claim 8, the mouse further comprising a printed circuit board for coupling the controller to the switch.

14. A power saving method of a mouse, the mouse comprising a controller, the method comprising the steps of:
(1) detecting a status of the mouse not being in use for a period of time;
(2) activating an interrupt by the controller forcing the mouse to enter into a sleep mode; and
(3) the controller disabling the interrupt forcing the mouse to return to an operation mode as the mouse is touched.
